(19) United States
(12) Patent Application Publication
(10) Pub. No.: US 2025/0209373 A1
(43) Pub. Date: Jun. 26, 2025

(54) DATASET FEATURE TYPE INFERENCE

(71) Applicant: Fujitsu Limited, Kawasaki-shi (JP)

(72) Inventors: Sou HASEGAWA, Mountain View, CA (US); Lei LIU, Sunnyvale, CA (US); Wei-Peng CHEN, Fremont, CA (US)

(73) Assignee: Fujitsu Limited, Kawasaki-shi (JP)

(21) Appl. No.: 18/393,419

(22) Filed: Dec. 21, 2023

(51) Int. Cl. G06N 20/00

(52) U.S. Cl. CPC G06N 20/00

(57) ABSTRACT

According to an aspect of an embodiment, one or more operations may include accessing a dataset including multiple data subsets. Feature type candidates corresponding to the data subsets may be identified. The one or more operations may further include building first machine learning models using different sets of feature type candidates. Each of the different sets of feature type candidates may be scored based on respective accuracies, relative to the dataset, of each first machine learning model that respectively corresponds to each different set of feature type candidates. A final set of feature types may be selected from the different sets of feature type candidates based on the scores of the different sets of feature types. The operations may further include training a second machine learning model using a labeled dataset that is generated by applying the final set of feature types to the dataset.

### FIELD

The present disclosure generally relates to dataset feature type inference.

### BACKGROUND

Machine learning (ML) models are trained using a training dataset. Quality of the training dataset affects the accuracy and the reality of the predictions made by the ML models. For instance, the training dataset may define the prediction patterns of the ML models. A well-diversified and representative training dataset that includes various scenarios and features may allow the ML models to make valid predictions on different and various input data.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, one or more operations may include accessing a dataset including multiple data subsets. Feature type candidates corresponding to the data subsets may be identified. The one or more operations may further include building first machine learning models using different sets of feature type candidates. Each of the different sets of feature type candidates may be scored based on respective accuracies, relative to the dataset, of each first machine learning model that respectively corresponds to each different set of feature type candidates. A final set of feature types may be selected from the different sets of feature type candidates based on the scores of the different sets of feature types. The operations may further include training a second machine learning model using a labeled dataset that is generated by applying the final set of feature types to the dataset.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1 illustrates an example system to train a machine learning model;

FIG. 2 illustrates an example process configured to perform feature type inference;

FIG. 3 is a flowchart of an example method of performing feature type inference; and

FIG. 4 illustrates an example computing system, all in accordance with one or more embodiments of the present disclosure.

### DETAILED DESCRIPTION

Machine learning models may be trained using a training dataset to make predictions. The training dataset may include training instances or individual data points used to train the ML model. Individual data points may correspond to features and a target variable that the ML model may be designed to predict. The features may define the characteristics of the data that the ML model may use to make predictions. For example, the ML model may perform different types of processing or analysis of the data depending on different characteristics of the data, which may be defined by different feature types. The features may include various data types such as numerical, categorical, text-based, among others.

In some instances, the training dataset may be represented in different formats suitable for the ML models. For instance, the training dataset may be represented in a tabular format having multiple columns and rows. In such instances, the columns may correspond to certain features having different feature types, and the rows may represent individual instances or data points of the features.

According to one or more embodiments of the present disclosure, feature types of a training dataset may be identified. For example, a feature type inference may be performed with respect to the training dataset. For instance, different types of data in the training dataset may be identified and labeled with corresponding feature types. For example, in instances in which the training dataset is represented as a tabular dataset, different columns may represent different types of data. In such instances, the feature type inference process may determine and accordingly label each column or subset of the training dataset with a respective feature type that at least partially defines one or more characteristics of the data included in the corresponding column.

In some embodiments, based on the different types of data (as indicated by the identified feature types) the training dataset may be adjusted. For example, in some embodiments, various large language model prompts may be generated and provided to a large language model. The responses from the large language model may be used to adjust the training dataset by improving existing data and/or adding additional data. Adjusting the training dataset using the large language model may improve scope and comprehensiveness of the training dataset. As a result, the machine learning models generated using the training dataset may be improved. For example, the machine learning models may be more robust and more accurately predict a target feature.

Embodiments of the present disclosure are explained with reference to the accompanying figures.

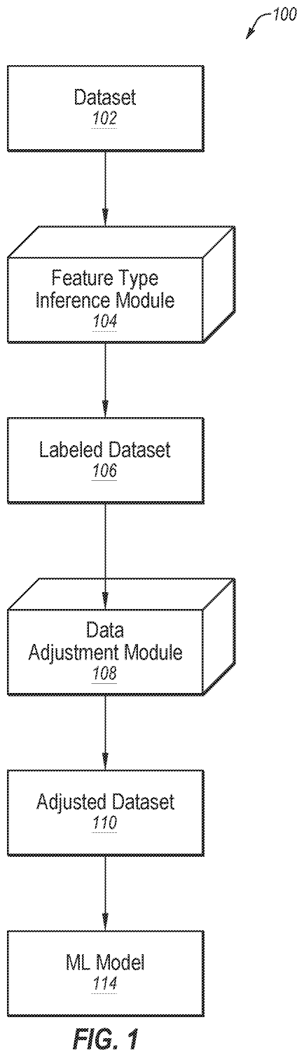

FIG. 1 illustrates an example system 100 configured for machine learning training, in accordance with one or more embodiments of the present disclosure. In general, the system 100 may be configured to train and/or generate an ML model 114. In some embodiments, the system 100 may be configured to train the ML model 114 using a dataset 102 that may be adjusted or enhanced to improve the training of the ML model 114.

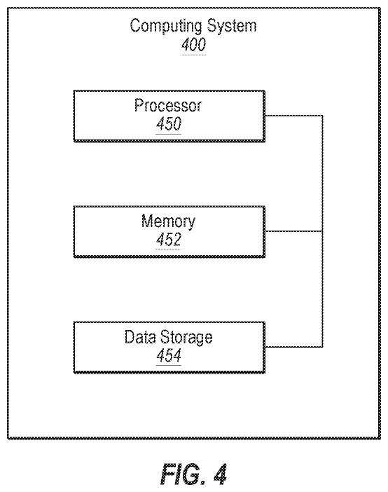

In some embodiments, the system 100 may include a feature type inference (FTI) module 104, and a data adjustment module 108, which may be generally referred to as “the modules.” In some embodiments, one or more of the modules may include code and routines configured to allow a computing system to perform one or more operations. Additionally or alternatively, one or more of the modules may be implemented using hardware including one or more processors, CPUs graphics processing units (GPUs), data processing units (DPUs), parallel processing units (PPUs), microprocessors (e.g., to perform or control performance of one or more operations), field-programmable gate arrays (FPGA), application-specific integrated circuits (ASICs), accelerators (e.g., deep learning accelerators (DLAs)), and/or other processor types. In these and other embodiments, one or more of the modules may be implemented using a combination of hardware and software. In the present disclosure, operations described as being performed by a particular module may include operations that the particular module may direct a corresponding computing system to perform. In these and other embodiments, one or more of the modules may be implemented by one or more computing systems, such as that described in further detail with respect to FIG. 4.

In some embodiments, the dataset 102 may be a training dataset that may be used to train the ML model 114. The dataset 102 may be obtained from any source or constructed using any data compilation technique. The data may include numerical data, character strings that include characters, such as letters, symbols, or other characters, numbers, or a combination of numbers and characters. The data may also include other formats of data.

In some embodiments, the data in the dataset 102 may be organized into one or more data subsets. For example, data of the same category may be organized into the same data subset. For instance, an example of the data may be real estate data that includes addresses, lot values, lot sizes, and lot improvements. As an example, the data representing the lot values may form part of a data subset.

In these and other embodiments, the data of the same category and grouped in a data subset may be referred to as a feature of the dataset 102. As an example, the dataset 102 may include tabular data that may be arranged in columns and rows. In these and other embodiments, each of the columns may represent a feature of the dataset 102 and each of the rows may include values in one or more of the columns. The values in one of the rows may be associated together. For example, following the previous example, the values for each of the columns in a single row may be associated with the same address.

In some embodiments, the data subsets of the dataset 102 may include various types of features. In such instances, the different types of features may be identified, and the one or more data subsets may be labeled according to associated types of features.

The FTI module 104 may be configured to analyze the data in the one or more data subsets of the dataset 102 to identify the different types of features included in the one or more data subsets. The one or more data subsets may be labeled accordingly to indicate the types of features included in the one or more data subsets. For instance, the FTI module 104 may generate a labeled dataset 106 which may correspond to the dataset 102 with feature labels corresponding to the feature types of the data subsets of the dataset 102. In some instances, the different data types (e.g., as indicated by the feature labels) may include categorical variables (e.g., textual features), identifier (ID) style features (e.g., numerical IDs, alphanumeric codes, etc.), among others. For example, a first data subset may include addresses and a second data subset may include income values. The first data subset and the first data subset may not have labels identifying the type of the data prior to the dataset 102 being analyzed by the FTI module 104. The corresponding labeled dataset 106 (e.g., as generated by the FTI module 104) may include the first data subset labeled as addresses and the second data subset labeled as income.

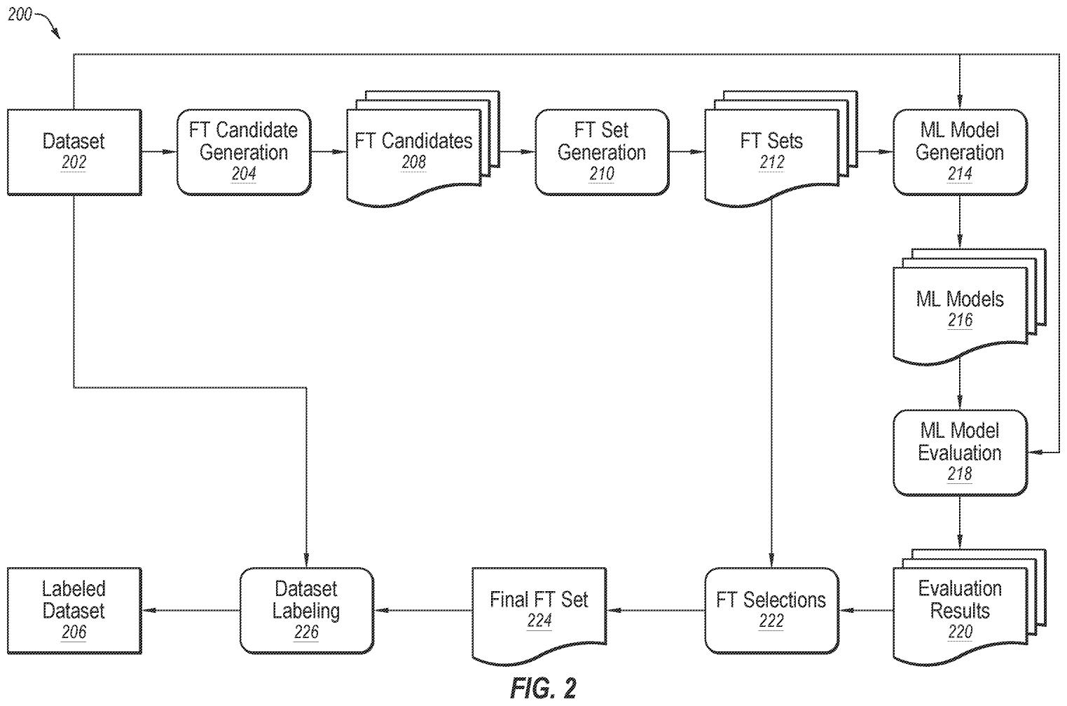

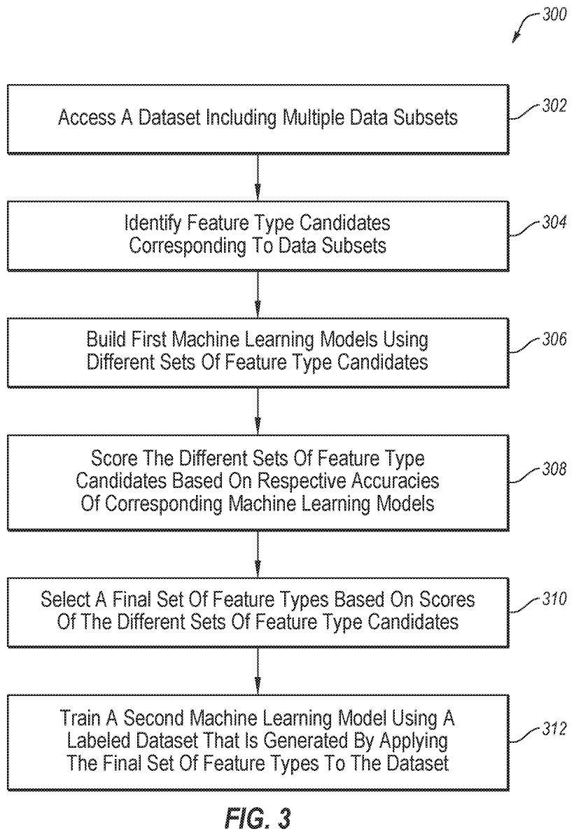

Additionally or alternatively, the corresponding labeled dataset 106 may include feature type indications relating to characteristics of the first data subset and the second data subset. For example, the first data subset may have a feature type of “sentence” associated therewith. Additionally or alternatively, the second data subset may have a feature type of “currency” associated therewith. In some embodiments, the FTI module 104 may perform one or more operations described in the present disclosure with respect to FIGS. 2 and 3 as part of the feature type inference and generation of the labeled dataset 106.

In some embodiments, the labeled dataset 106 may be processed by the data adjustment module 108 to generate the adjusted dataset 110. In these and other embodiments, the data adjustment module 108 may perform one or more algorithms and/or operations to adjust the scope of the labeled dataset 106. As an example, the dataset 102 may be adjusted such that the scope of the dataset 102 may be broadened.

In some embodiments, the data adjustment module 108 may be configured to command a large language model (LLM) to generate one or more additional features with respect to the labeled dataset 106. The one or more additional features may be used to generate the adjusted dataset 110. For instance, the adjusted dataset 110 may include additional data in addition to the existing data of the dataset 102. In some embodiments, the one or more additional features generated by the LLM may vary based on the types of features corresponding to the one or more data subsets. For example, the one or more additional features may include enhancement of existing data and the addition of external data determined based on the existing data. In some instances, the enhancement to the existing data may include additional grouping or dividing of the existing data such that at least one new feature is generated. The new feature may make a portion of the existing data more distinct within the dataset 102. Contrastingly, the external data may include new data that is not present in the dataset 102 but that may be related to at least one existing feature of the dataset 102. One or more examples of the data adjustment process are further discussed and described in U.S. Patent Application entitled “Data Adjustment Using Large Language Model”, by Lei Liu, Wei-Peng Chen, and Sou Hasegawa (Atty. Docket No. F1423.10580US01) filed on Dec. 21, 2023 and incorporated by reference in its entirety.

In some embodiments, the adjusted dataset 110 may be used to train the ML model 114. For instance, the ML training module 112 may provide the adjusted ML model 114 may learn the patterns and/or relationships between the features and the target feature in the adjusted dataset 110, such that the ML model 114 may predict a value for the target feature when given values of the other features. In some embodiments, the ML model 114 may be any type of ML model. For example, the ML model may be a supervised learning model (e.g., regression model, classification model), an unsupervised learning model (e.g., clustering model), a deep learning model (e.g., convolutional neural networks, recurrent neural networks, transformer models), among others.

As indicated, the ML model 114 may be used to predict the values of the target feature. For example, a dataset that includes one or more of the features of the dataset may be provided to the ML model 114. The ML model 114 may predict a value of the target feature based on the values of the one or more features provided. By providing the adjusted dataset 110 (e.g., a dataset with more features than the dataset 102) the ML model 114 may more accurately predict the value of the target feature. Thus, adjustment of the dataset 102 to generate the adjusted dataset 110 may improve the training of the ML model 114 and may accordingly improve machine learning technology.

Modifications, additions, or omissions may be made to the system 100 without departing from the scope of the present disclosure. For example, in some embodiments, the system 100 may include any number of other components that may not be explicitly illustrated or described. Further, the system 100 may perform any number of operations not explicitly described and/or may not perform all of the operations explicitly described without departing from the scope of the present disclosure.

FIG. 2 illustrates an example process 200 for generating a labeled dataset 206 based on a dataset 202, according to one or more embodiments of the present disclosure. In some embodiments other more operations of the process 200 may be performed by the FTI module 104 of FIG. 1.

The dataset 202 may be similar or analogous to the dataset 102 of FIG. 1. Additionally or alternatively the labeled data set 206 maybe similar or analogous to the labeled data set 106 of FIG. 1.

In embodiments the process 200 may include a feature type (FT) candidate generation operation 204 “FT candidate generation 204”. The FT candidate generation 204 may include one or more operations that may be performed with respect to the dataset 202 to identify one or more FT candidates 208.

In some embodiments, the FT candidate generation 204 may include identifying different feature type candidates for the different subsets of the dataset 202. For example, the dataset 202 may include multiple columns of data that may respectively correspond to a certain feature. In these and other embodiments, the FT candidate generation 204 may include identifying sets of feature type candidates for each of one or more of the columns that are candidate feature types of the features respectively corresponding to the columns.

In some embodiments, one or more operations of the FT candidate generation 204 may be performed by a feature type inference model (FTI model). In some embodiments, the FTI model may include any suitable ML model that may be configured to analyze the dataset 202 and predict potential feature types (e.g., feature type candidates) for the different subsets of the dataset 202. For example, in some embodiments, the FTI model may predict different feature type candidates for one or more of the data subsets. Additionally or alternatively, the FTI model may assign a probability value for each feature type candidate. The probability value may indicate a likelihood that the corresponding feature type candidate is the actual feature type of the corresponding data subset.

In some embodiments, respective groups of feature type candidates may be organized for the data subsets of the dataset 202. For example, the feature type candidates that are identified for each of one or more of the data subsets may be included in respective groups that correspond to the data subsets.

In some embodiments the FT candidate generation 204 may include filtering out one or more feature type candidates from the groups of feature type candidates. For example, in some embodiments, feature type candidates having a probability value that does not meet a particular probability threshold (e.g., 0.25) may be removed from one or more of the groups of feature candidates. For instance, a particular group of feature type candidates that corresponds to a particular data subset may include a first number of feature type candidates for the particular data subset. In these and other embodiments, feature type candidates that do not satisfy the probability threshold may be removed from the particular group of feature type candidates such that the particular group of feature type candidates may have a second number of feature type candidates that is smaller than the first number.

Additionally or alternatively, the FT candidates 208 of one or more of the groups may be filtered based on rankings of the FT candidates 208 within the respective groups. The rankings may be based on the corresponding probability values. For example, in some embodiments, a threshold number “m” of FT candidates 208 may be set such that none of the groups may exceed “m” number of FT candidates 208. In these and other embodiments, the FT candidates 208 in each group may be ranked according to their respective probability values and the top “m” FT candidates 208 may be kept in the groups while the others may be removed. In some embodiments, “m” may be a fixed number. Additionally or alternatively, the value of “m” may be based on a certain percentage of FT candidates 208. In these and other embodiments, the value of “m” may be based on computing resources (e.g., processing capacity, memory availability, etc.) that may be available for performing the process 200. The groups of feature type candidates before or after filtering may respectively include one or more feature type candidates.

In some embodiments, the FTI model may be configured to predict the feature type candidates from previously defined feature types. The training of the FTI model using the training dataset having defined feature types may result in the FTI model being trained to predict which of such feature types may correspond to data subsets of the dataset 202.

For example, in some embodiments, the FTI model may be trained using a training dataset having feature types that are defined according to the one or more of the following categories: numeric, categorical, date/time, text, int, float, double timestamp, and string. Additionally or alternatively, rather than having a generic “text” feature type, the training dataset may have more specific feature types for text such as indicated in Table 1 below (which may correspond to defined “SortingHat” feature type categories).

TABLE 1

| Feature Type | Description | Sample values |
|---|---|---|
| Datetime | Date/time | Dec. 30, 2011, 2005 Oct. 1 |
| Sentence | Sequence of words | Today is a beautiful day. |
| URL | Uniform resource locator | https://www.example.com |
| Embed | String with numerical values | 9,900,900, 8000 retweets |
| | embedded | |
| List | Collection of values, grouped | [1, 2, 3], [good, bad, |
| | together | normal] |
| Unit | String including units | 12.0 kg, 8000 km |
| Range | String including range of two | 900-1200, 800:1000 |
| | numerical values | |
| Inequality | String including inequality | >300, <100 |
| Sign | sign | |
| Location | Name or address associated | Paris, 350 Cobalt Way |
| | with geological location | |
| Currency | String including currency | $8000, 9000 USD |
| | mark | |
| Filepath | Path to files | /data/image/image1.png |
| Phone- | Phone number | 888-8888 |
| number | | |
| Name | Names of persons | John Doe |

In some embodiments, one or more training datasets used to train the FTI model may include data subsets that are already labeled according to a previously defined feature type, such as described above. Additionally or alternatively, one or more training data sets used to train the FTI model may include one or more data subsets that are not labeled according to a previously defined feature type and/or that do not have features that correspond to a previously defined feature type. In these and other embodiments, the training dataset used to train the FTI may be augmented to include additional defined feature types.

For example, for the data subsets (e.g., columns) that do not correspond to (e.g., overlap with) a previously defined feature type (e.g., a feature type described above), one or more rules may be applied to obtain and/or generate sample values that correspond to such feature types, which may be provided to the FTI model to train the FTI model on such feature types.

The FT candidates 208 may include the feature type candidates that may be respectively identified for the data subsets included in the dataset 202. In some embodiments, the FT candidates 208 may be organized into the respective groups of feature type candidates that correspond to the different data subsets. As indicated above, the groups may each respectively include one or more feature type candidates for their corresponding data subset. In some embodiments, one or more of the groups may be those remaining after performing filtering based on probability values, such as described above. Additionally or alternatively, one or more of the groups may include the feature type candidates predicted for corresponding data subsets without any filtering having been performed.

In these and other embodiments, the FT candidates 208 may include the respective probability values associated with the respective feature type candidates and their corresponding data subsets. As indicated above, the respective probability values may indicate the respective probabilities that the corresponding feature type candidate is the actual feature type of the corresponding data subset.

In some embodiments, the process 200 may include a feature type set generation operation 210 (FT set generation 210). The FT set generation 210 may include one or more operations corresponding to organizing the FT candidates 208 into one or more FT sets 212. In some embodiments, the FT set generation 210 may include identifying different combinations of FT candidates 208 based on the groups of FT candidates. In these and other embodiments, the FT set generation 210 may include identifying every different possible combination of FT candidates 208 based on every group of FT candidates 208.

For example, the dataset 202 may include “n” different data subsets such that the FT candidates 208 may be organized “n” ten different groups of FT candidates 208, one group for each data subset. Further, each of the “n” groups of FT candidates 208 may have a certain number of FT candidates 208 included therein, which may vary from group to group. The different combinations of FT candidates 208 may each include “n” number of FT candidates 208 in which each FT candidate of a particular combination is selected from a different one of the groups of FT candidates 208. Additionally or alternatively, every possible combination of “n” number of FT candidates 208 may be identified based on the different FT candidates included in the groups of FT candidates.

In these and other embodiments, the FT sets 212 may each respectively correspond to one of the combinations of FT candidates 208. In some embodiments, the total number of combinations of FT candidates may be very large (e.g., thousands or millions of combinations). This number may depend on the number of different groups of FT candidates 208 (which may be dictated by the number of data subsets) and depending on the number of FT candidates 208 included in each group of FT candidates 208. As such, in some instances, the total number of FT sets 212 may be very large.

In some embodiments, the FT sets 212 may be filtered. For example, in some embodiments, a combined probability may be determined for each respective FT set 212 and the FT sets 212 may be filtered based on the combined probabilities. For example, the FT sets 212 may be ranked according to their respective combined probabilities and a threshold number of the highest ranked FT sets 212 may be selected while the others may be filtered out. In these and other embodiments, the FT sets 212 may be filtered based on a threshold percentage of the FT sets 212 in which the highest ranked FT sets 212 within the threshold percentage may be selected and those outside of the threshold percentage (e.g., as ranked) may be filtered out.

Additionally or alternatively, the FT sets 212 may be filtered based on a combined probability threshold. For example, FT sets 212 that satisfy the combined probability threshold may be selected and FT sets 212 that do not satisfy the combined probability threshold may be filtered out. In these and other embodiments, the threshold that may be used for filtering the FT sets 212 may be based on computing resources (e.g., processing capacity, memory availability, etc.) that may be available for performing the process 200.

The combined probabilities of the FT sets 212 may be determined according to any suitable technique. For example, in some embodiments, the probabilities of each feature type candidate included in the respective FT sets 212 may be multiplied to obtain the corresponding combined probabilities. For instance, a particular FT set 212 may include four feature type candidates that may respectively have probability values “p1”, “p2”, “p3”, and “p4”. A particular combined probability “Cp” for the particular FT set 212 may be determined by the following expression:

$$Cp = p 1 * p 2 * p 3 * p 4$$

In some embodiments, the process 200 may include a machine learning model generation operation 214 (ML model generation 214). The ML model generation 214 may include one or more operations that are used to generate feature type ML models 216 (ML models 216) based on the FT sets 212 and the dataset 202. In some embodiments, a respective ML model 216 may be generated for each of the FT sets 212. In these and other embodiments, the ML models 216 may be generated for FT sets 212 that remain after filtering out one or more FT sets 212, such as described above. In the present disclosure, reference to a machine learning model being a “feature type” machine learning model is only meant to indicate the ML models that are generated using the FT sets 212 as a way to differentiate from other ML models described herein.

For example, in some embodiments, a particular FT set 212 may be provided to an auto machine learning model generator (ML generator). Additionally or alternatively, in some embodiments, the ML generator may include a rule-based ML generator that is configured to generate a particular machine learning pipeline (ML pipeline) based on the particular FT set 212.

For instance, the particular ML pipeline may include the data processing and modeling that may be used to generate a particular ML model corresponding thereto. Additionally or alternatively, different preprocessors that may be included in the ML pipelines may be better suited for analyzing data having characteristics corresponding to some feature types than others. As such, certain preprocessors may be selected for inclusion in the particular ML pipeline depending on the feature types included in the particular FT set 212 that is provided to the ML generator for generation of the particular ML pipeline.

In some embodiments, the ML generator may apply rules to the feature types corresponding to the different data subsets (e.g., as indicated in the particular FT set 212) to determine which preprocessor may be used to analyze the respective data subsets. In some embodiments, the process of providing individual ML sets 212 to the ML generator may be performed with respect to each FT set 212 such that the ML generator may generate a corresponding ML pipeline for each FT set 212. In these and other embodiments, training data may be provided to the individual ML pipelines, which may process the training data in which the training data processing by the ML pipelines may create corresponding ML models 216. In some embodiments, each ML model 216 may accordingly correspond to one of the FT sets 212 and may be generated based on a corresponding FT set 212.

In some embodiments, the training data that is used to generate and train the ML models 216 may be the same for each ML model 216. Additionally or alternatively, the training data used to generate and train two or more of the ML models 216 may be different.

In some embodiments, the training data may be sampled from the dataset 202. In these and other embodiments, the sampling strategy may vary depending on the ML type of the ML pipeline being used to generate the corresponding ML model 216.

For example, for ML pipelines corresponding to classification tasks and operations, a certain number of instances of each corresponding data subset of the dataset 202 may be sampled for the training data. In these and other embodiments, the instances may be sampled randomly from the corresponding data subsets. Additionally or alternatively, in instances in which a particular data subset does not include the certain number of instances, all of the instances may be sampled as the training data.

As another example, for ML pipelines that correspond to regression tasks and operations, continuous values of corresponding data subsets included in the dataset 202 may be converted into discrete values using any suitable technique. For example, in some embodiments, Doane's rule may be used to convert the continuous values into discrete values. In these and other embodiments, following the conversion, a certain number of instances of the discrete values may be sampled. In these and other embodiments, the instances may be sampled randomly from the corresponding data subsets. Additionally or alternatively, in instances in which a particular data subset does not include the certain number of instances, all of the instances may be sampled as the training data. In some embodiments, the number of samples for classification may be the same as those for regression. In these and other embodiments, the number of samples for classification may differ from those for regression.

In some embodiments, the process 200 may include an ML model evaluation operation 218 (ML model evaluation 218). The ML model evaluation 218 may include one or more operations that may be used to determine an accuracy of the ML models 216. In some embodiments, the ML model evaluation 218 may be based on the dataset 202.

For example, validating data that is sampled from the dataset 202 may be provided as input data to each of the ML models 216. In some embodiments, the validating data may be sampled in a manner similar or analogous to the training data. Additionally or alternatively, the validating data may be at least partially different from the training data. Further, the number of samples used for the validating data may be different from or the same as the number of samples used for the training data. For example, in some embodiments, the number of samples obtained for a particular data subset for the training data may be greater than the number of samples of the particular data subset obtained for the validating data.

The ML models 216 may perform one or more predications based on the validating data provided thereto and may output such predictions. The outputs may be verifiable using the data included in the dataset 202 and a corresponding accuracy may be determined for each ML model 216. For example, in some embodiments, each ML model 216 may be given a score that is based on its accuracy. In some embodiments, the accuracy determinations for each of the respective ML models 216 may be included in evaluation results 220. Additionally or alternatively, the FT sets 212 corresponding to the ML models 216 may be scored according to the accuracies of the corresponding ML models 216. For example, a particular FT set 212 may be used to generate a particular ML model 216. A particular accuracy may be determined with respect to the particular ML model 216. Additionally or alternatively, the particular accuracy corresponding to the particular ML model 216 may be used to determine a score corresponding to the particular FT set 212 used to generate the particular ML model 216.

In some embodiments, the process 200 may include a feature type selection operation 222 (FT selection 222). The FT selection 222 may select a particular FT set 212 from the FT sets 212 as the corresponding feature types for the data subsets of the dataset 202. In some embodiments, the FT selection 222 may be based on the evaluation results 220. For example, the FT selection 222 may identify, based on the evaluation results 220, which of the ML models 216 was the most accurate as identified by the ML model evaluation 218. In these and other embodiments, the FT selection 222 may identify which of the FT sets 212 was used to generate the most accurate ML model 216. The identified FT set 212 may then be selected as a final set of feature types 224 (final FT set 224).

In some embodiments, the process 200 may include a dataset labeling operation 226. The dataset labeling operation 226 may be configured to generate the labeled dataset 206 based on the dataset 202 and the final FT set 224. For example, the dataset labeling operation 226 may annotate the data subsets of the dataset 202 with the corresponding feature types included in the final FT set 224.

Therefore, the process 200 may be configured to perform feature type inference with respect to the dataset 202 to identify the feature types of the dataset 202. As indicated herein, the feature type identification may be used to adjust training datasets to improve machine learning model training. Additionally or alternatively, the feature type inference described herein provides a particular process that may be used to automate feature type identification of training datasets, which improves the efficiency of generating training data for machine learning. The improved training data efficiency therefore improves the training efficiency of machine learning and accordingly improves the technology itself.

FIG. 3 illustrates a flowchart of an example method 300 of performing feature type inference, in accordance with one or more embodiments of the present disclosure. The method 300 may be performed by any suitable system, apparatus, or device. For example, the method 300 may be implemented using the system 100 of FIG. 1 or the computing system 400 of FIG. 4. Although illustrated with discrete blocks, the steps and operations associated with one or more blocks of the method 300 may be divided into additional blocks, combined into fewer blocks, or eliminated, depending on the particular implementation. For example, one or more of the operations described above with respect to the process 200 of FIG. 2 may be performed as part of the method 300.

The method 300 may include block 302. At block 302 a dataset that includes multiple data subsets may be accessed. The feature types corresponding to the data subsets may not have been identified yet. The datasets 102 and 202 described with respect to FIGS. 1 and 2, respectively, may be examples of the accessed dataset.

At block 3041, feature type candidates corresponding to the data subsets may be identified. In some embodiments, the feature type candidates may be identified based on one or more of the operations described with respect to the FT generation 204 of FIG. 2.

At block 306, first machine learning models may be generated using different sets of the feature type candidates. In some embodiments, the different sets of feature type candidates may be identified based on one or more operations described with respect to FT set generation 210 of FIG. 2. Additionally or alternatively, the ML models 216 of FIG. 2 may be examples of the first machine learning models. In these and other embodiments, the first machine learning models may be generated based on one or more operations described with respect to ML model generation 214 of FIG. 2.

At block 308, each of the different sets of feature type candidates may be scored. Additionally or alternatively, the scoring may be based on respective accuracies, relative to the dataset, of the first machine learning models that respectively correspond to the different sets of feature type candidates. In some embodiments, the accuracies of the first machine learning models may be determined based on one or more operations described with respect to ML model evaluation 218 of FIG. 2. Additionally or alternatively, the scoring of the different sets of feature type candidates may be performed using one or more operations described with respect to ML model evaluation 218 of FIG. 2.

At block 310, a final set of feature types may be selected from the different sets of feature type candidates. In some embodiments, the final set of feature types may be selected based on one or more operations described with respect to FT selection 222 of FIG. 2.

In some embodiments, the final set of feature types may be applied to the dataset to generate a labeled dataset. For example, in some embodiments, the labeled dataset may be generated based on one or more operations described with respect to dataset labeling 226 of FIG. 2.

At block 312, a second machine learning model may be trained using the labeled dataset. Additionally or alternatively, in some embodiments, the labeled dataset may be adjusted in which the adjustment may use the feature type indications included in the labeled dataset. The adjusted dataset may then be used for training the second machine learning model.

Modifications, additions, or omissions may be made to the method 300 without departing from the scope of the present disclosure. For example, one or more operations may be included or omitted.

FIG. 4 illustrates a block diagram of an example computing system 400, according to at least one embodiment of the present disclosure. The computing system 400 may be configured to implement or direct one or more suitable operations described in the present disclosure. For example, the computing system 400 may be configured to perform one or more blocks of the process 200 of FIG. 2, or the method 300 of FIG. 3. Additionally or alternatively, one or more of the modules of FIG. 1 may be implemented by or include the computing system 400. The computing system 500 may include a processor 550, a memory 552, and a data storage 554. The processor 550, the memory 552, and the data storage 554 may be communicatively coupled.

In general, the processor 550 may include any suitable special-purpose or general-purpose computer, computing entity, or processing device including various computer hardware or software modules and may be configured to execute instructions stored on any applicable computer-readable storage media. For example, the processor 550 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 550 may include any number of processors configured to, individually or collectively, perform or direct performance of any number of operations described in the present disclosure. Additionally, one or more of the processors may be present on one or more different electronic devices, such as different servers.

In some embodiments, the processor 550 may be configured to interpret and/or execute program instructions and/or process data stored in the memory 552, the data storage 554, or the memory 552 and the data storage 554. In some embodiments, the processor 550 may fetch program instructions from the data storage 554 and load the program instructions in the memory 552. After the program instructions are loaded into memory 552, the processor 550 may execute the program instructions.

The memory 552 and the data storage 554 may include computer-readable storage media for carrying or having computer-executable instructions or data structures stored thereon. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store particular program code in the form of computer-executable instructions or data structures and which may be accessed by a general-purpose or special-purpose computer. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007).

Combinations of the above may also be included within the scope of computer-readable storage media. Computer-executable instructions may include, for example, instructions and data configured to cause the processor 550 to perform a certain operation or group of operations.

Modifications, additions, or omissions may be made to the computing system 500 without departing from the scope of the present disclosure. For example, in some embodiments, the computing system 500 may include any number of other components that may not be explicitly illustrated or described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
accessing a dataset including a plurality of data subsets;
identifying a plurality of feature type candidates corresponding to the plurality of data subsets;
building a plurality of first machine learning models using different sets of feature type candidates;
scoring each of the different sets of feature type candidates based on respective accuracies, relative to the dataset, of each first machine learning model of the plurality of first machine learning models that respectively corresponds to each different set of feature type candidates;
selecting a final set of feature types from the different sets of feature type candidates based on the scores of the different sets of feature type candidates; and
training a second machine learning model using a labeled dataset that is generated by applying the final set of feature types to the dataset.

2. The method of claim 1, wherein the feature type candidates of the plurality of feature type candidates are identified based on an inference type machine learning analysis of the dataset.

3. The method of claim 2, wherein the method further comprises filtering the feature type candidates based on respective probability values corresponding to likelihoods that the feature type candidates are actual feature types corresponding to their respective data subsets.

4. The method of claim 1, wherein the different sets of feature type candidates are based on different combinations of feature type candidates corresponding to different data subsets.

5. The method of claim 1, wherein the different sets of feature type candidates are selected based on respective combined probability values for each set of feature type candidates, the respective combined probability values being determined based on respective individual probability values of individual feature type candidates included in a corresponding set of feature type candidates, the respective individual probability values corresponding to likelihoods that the corresponding feature type candidates are actual feature types corresponding to their respective data subsets.

6. The method of claim 1, wherein the building of the plurality of first machine learning models includes training the plurality of first machine learning models using data sampled from the dataset.

7. The method of claim 1, further comprising determining the respective accuracies of the plurality of first machine learning models based on data sampled from the dataset that is used as validation data for the plurality of first machine learning models.

8. One or more non-transitory computer-readable media storing instructions that, in response to being executed by one or more processors, cause a system to perform operations, the operations comprising:
accessing a dataset including a plurality of data subsets;
identifying a plurality of feature type candidates corresponding to the plurality of data subsets;
building a plurality of first machine learning models using different sets of feature type candidates;
scoring each of the different sets of feature type candidates based on respective accuracies, relative to the dataset, of each first machine learning model of the plurality of first machine learning models that respectively corresponds to each different set of feature type candidates;
selecting a final set of feature types from the different sets of feature type candidates based on the scores of the different sets of feature type candidates; and
training a second machine learning model using a labeled dataset that is generated by applying the final set of feature types to the dataset.

9. The one or more non-transitory computer-readable media of claim 8, wherein the feature type candidates of the plurality of feature type candidates are identified based on an inference type machine learning analysis of the dataset.

10. The one or more non-transitory computer-readable media of claim 9, wherein the operations further comprise filtering the feature type candidates based on respective probability values corresponding to likelihoods that the feature type candidates are actual feature types corresponding to their respective data subsets.

11. The one or more non-transitory computer-readable media of claim 8, wherein the different sets of feature type candidates are based on different combinations of feature type candidates corresponding to different data subsets.

12. The one or more non-transitory computer-readable media of claim 8, wherein the different sets of feature type candidates are selected based on respective combined probability values for each set of feature type candidates, the respective combined probability values being determined based on respective individual probability values of individual feature type candidates included in a corresponding set of feature type candidates, the respective individual probability values corresponding to likelihoods that the corresponding feature type candidates are actual feature types corresponding to their respective data subsets.

13. The one or more non-transitory computer-readable media of claim 8, wherein the building of the plurality of first machine learning models includes training the plurality of first machine learning models using data sampled from the dataset.

14. The one or more non-transitory computer-readable media of claim 8, wherein the operations further comprise determining the respective accuracies of the plurality of first machine learning models based on data sampled from the dataset that is used as validation data for the plurality of first machine learning models.

15. A system, comprising:
one or more processors; and
one or more non-transitory computer-readable storage media configured to store instructions that, in response to being executed, cause the system to perform operations, the operations comprising:
accessing a dataset including a plurality of data subsets;
identifying a plurality of feature type candidates corresponding to the plurality of data subsets;
building a plurality of first machine learning models using different sets of feature type candidates;
scoring each of the different sets of feature type candidates based on respective accuracies, relative to the dataset, of each first machine learning model of the plurality of first machine learning models that respectively corresponds to each different set of feature type candidates;
selecting a final set of feature types from the different sets of feature type candidates based on the scores of the different sets of feature type candidates; and
training a second machine learning model using a labeled dataset that is generated by applying the final set of feature types to the dataset.

16. The system of claim 15, wherein:
the feature type candidates of the plurality of feature type candidates are identified based on an inference type machine learning analysis of the dataset; and
the operations further comprise filtering the feature type candidates based on respective probability values corresponding to likelihoods that the feature type candidates are actual feature types corresponding to their respective data subsets.

17. The system of claim 15, wherein the different sets of feature type candidates are based on different combinations of feature type candidates corresponding to different data subsets.

18. The system of claim 15, wherein the different sets of feature type candidates are selected based on respective combined probability values for each set of feature type candidates, the respective combined probability values being determined based on respective individual probability values of individual feature type candidates included in a corresponding set of feature type candidates, the respective individual probability values corresponding to likelihoods that the corresponding feature type candidates are actual feature types corresponding to their respective data subsets.

19. The system of claim 15, wherein the building of the plurality of first machine learning models includes training the plurality of first machine learning models using data sampled from the dataset.

20. The system of claim 15, wherein the operations further comprise determining the respective accuracies of the plurality of first machine learning models based on data sampled from the dataset that is used as validation data for the plurality of first machine learning models.
